(19) United States
(12) Patent Application Publication
(10) Pub. No.: US 2024/0262698 A1
(43) Pub. Date: Aug. 8, 2024

(54) SILICA SOL

(71) Applicant: FUJIMI INCORPORATED, Kiyosu-shi (JP)

(72) Inventors: Shogo TSUBOTA, Kiyosu-shi (JP); Masaaki ITO, Kiyosu-shi (JP); Keiji ASHITAKA, Kiyosu-shi (JP); Yusuke KAWASAKI, Kiyosu-shi (JP); Kazuaki IWASAKI, Kiyosu-shi (JP)

(73) Assignee: FUJIMI INCORPORATED, Kiyosu-shi (JP)

(21) Appl. No.: 18/429,695

(22) Filed: Feb. 1, 2024

(30) Foreign Application Priority Data
Feb. 3, 2023 (JP) 2023-015022
Nov. 20, 2023 (JP) 2023-196490

(51) Int. Cl. C01B 33/141

(52) U.S. Cl. CPC C01B 33/141; C01P 2004/64; C01P 2006/22; C01P 2006/80

(57) ABSTRACT

A silica sol which does not gelate, has a high purity, and contains a high concentration of silica particles is provided. A silica sol containing silica particles and water, wherein a product of an average primary particle size of the silica particles and an average circularity of the silica particles is 15.0 or more and 31.2 or less, a concentration of the silica particles is 20 mass % or more, a total organic carbon amount per silica particle is less than 10 mass ppm, when the concentration of the silica particles is 20 mass %, a viscosity at 25° C. is 300 mPa·s or less, and a concentration of a metal impurity is less than 1 mass ppm.

### CROSS-REFERENCE TO RELATED APPLICATION

The present application is based on Japanese Patent Application No. 2023-015022 filed on Feb. 3, 2023 and Japanese Patent Application No. 2023-196490 filed on Nov. 20, 2023, the entire disclosures of which are incorporated herein by reference.

### BACKGROUND

### 1. Technical Field

The present invention relates to a silica sol.

### 2. Description of Related Arts

Conventionally, chemical mechanical polishing (CMP) using a polishing composition has been performed on a surface of a material such as a metal, a semimetal, a non-metal, or an oxide thereof. This polishing composition generally has a configuration in which an aqueous solution having a chemical polishing action and particles having a mechanical polishing action (abrasive grains) are mixed and dispersed, and it is known that a silica sol is used as abrasive grains.

For the purpose of improving production efficiency, storage and transport efficiency, or the like, attempts have been made to increase the concentration of silica particles in a silica sol. However, it is generally known that a silica sol gelates when the concentration of silica particles contained therein increases (for example, 20 mass % or more).

Meanwhile, WO 2008/015943 A discloses a technique in which a dispersant is added to a silica sol synthesized by an alkoxide method to set the concentration of silica particles in the silica sol to 20 wt % or more without causing gelation.

### SUMMARY

However, in the silica sol described in WO 2008/015943 A, a dispersant is added, and therefore gelation can be prevented, but there is a problem in achieving a high purity.

Therefore, the present invention has been made in view of the above circumstances, and an object of the present invention is to provide a silica sol that does not gelate, has a high purity, and contains a high concentration of silica particles.

The present inventors conducted intensive studies to solve the above problem. As a result, it was found that the above-mentioned problem is solved by a silica sol, which contains silica particles and water, and in which a product of an average primary particle size of the silica particles and an average circularity of the silica particles is 15.0 or more and 31.2 or less, a concentration of the silica particles is 20 mass % or more, a total organic carbon amount per silica particle is less than 10 mass ppm, when the concentration of the silica particles is 20 mass %, a viscosity at 25° C. is 300 mPa·s or less, and a concentration of a metal impurity is less than 1 mass ppm, leading to completion of the present invention.

### DETAILED DESCRIPTION

Hereinafter, embodiments according to one aspect of the present invention will be described. The present invention is not limited only to the following embodiments.

In the present specification, “X to Y” indicating a range means “X or more and Y or less”. In addition, unless otherwise specified, operations and measurements of physical properties and the like are performed under the conditions of room temperature (20 to 25° C.)/relative humidity of 40 to 50% RH.

### <Silica Sol>

One aspect of the present invention relates to a silica sol, which contains silica particles and water, and in which a product of an average primary particle size of the silica particles and an average circularity of the silica particles is 15.0 or more and 31.2 or less, a concentration of the silica particles is 20 mass % or more, a total organic carbon amount per silica particle is less than 10 mass ppm, when the concentration of the silica particles is 20 mass %, a viscosity at 25° C. is 300 mPa·s or less, and a concentration of a metal impurity is less than 1 mass ppm. According to the present invention, a silica sol which does not gelate, has a high purity, and contains a high concentration of silica particles is provided.

The present inventors presume a mechanism for solving the above-mentioned problem as follows.

When the concentration of silica particles in a silica sol is the same, the smaller the particle size, the larger the number of particles. Therefore, when the concentration of silica particles is increased through concentration, it is considered that since an inter-particle distance is short, a silica sol having a large number of particles gelates before a silica sol having a small number of particles.

However, dispersion and aggregation of silica particles in a silica sol can be explained by an electrostatic repulsive force derived from the zeta potential of silica particles and an attractive force derived from a van der Waals force between silica particles. This is also called DLVO theory (Derjaguin-Landau-Verwey-Overbeek theory), and when an electrostatic repulsive force is stronger than an attractive force derived from a van der Waals force, silica particles are dispersed in a silica sol, and conversely, silica particles tend to aggregate.

Here, according to the study of the present inventors, in a silica sol in which the concentration of silica particles is 20 mass % or more, a relationship between the particle size and shape and aggregation and dispersion is considered to be as follows:
(1) When the particle size of silica particles is smaller than a certain particle size range, the inter-particle distance becomes too short, and the van der Waals force derived from the inter-particle distance increases. Therefore, the attractive force derived from the van der Waals force becomes stronger than the repulsive force of the electrostatic repulsive action, and silica particles tend to aggregate.
(2) When the particle size of silica particles is within a certain particle size range, the van der Waals force derived from the inter-particle distance and the van der Waals force derived from the particle size and shape do not become so large. Therefore, the attractive force derived from the van der Waals force becomes weaker than the repulsive force of the electrostatic repulsive action, and silica particles do not aggregate and a high concentration can be achieved.
(3) When the particle size of silica particles is larger than a certain particle size range, the van der Waals force derived from the inter-particle distance decreases, but the van der Waals force derived from the particle size and the shape increases. Therefore, the attractive force derived from the van der Waals force becomes stronger than the repulsive force of the electrostatic repulsive action, and silica particles tend to aggregate.

From the above, it is considered that aggregation of silica particles in a silica sol is affected not only by the value of the particle size but also by the particle shape (when the particle sizes are the same, the attractive force derived from the van der Waals force is larger in a case where the shape is irregular). Therefore, it is considered that by controlling the shape of silica particles in addition to setting the particle size of silica particles within a certain range, it is possible to obtain a silica sol which does not gelate, has a high purity, and contains a high concentration of silica particles without adding a dispersant, modifying the surfaces of silica particles, adjusting the pH of the silica sol, or the like.

The above-mentioned mechanism is based on presumption, and whether it is correct or incorrect does not affect the technical scope of the present invention.

The silica sol according to the present invention contains silica particles and water.

The product of the average primary particle size (nm) of the silica particles and the average circularity of the silica particles is 15.0 or more and 31.2 or less. By setting the product of the average primary particle size of the silica particles and the average circularity of the silica particles within such a range, gelation can be prevented even when the concentration of the silica particles is 20 mass % or more. The product of the average primary particle size of the silica particles and the average circularity of the silica particles is preferably 16.0 or more and 31.1 or less, more preferably 16.5 or more and 30.0 or less, and still more preferably 20.0 or more and 27.0 or less. Within such a range, a silica sol having a higher concentration of silica particles can be obtained.

In the silica sol according to the present invention, the average primary particle size and the average circularity of the silica particles are not particularly limited as long as they satisfy the range of the product of the average primary particle size of the silica particles and the average circularity of the silica particles. The average primary particle size and the average circularity of the silica particles can be controlled by a conventionally known method. The controlling method will be described in a method for producing a silica sol described later.

The lower limit of the average primary particle size of the silica particles is 15.0 nm or more, preferably 16.5 nm or more, and more preferably 20.0 nm or more. The upper limit of the average primary particle size of the silica particles is preferably 39.0 nm or less, more preferably 34.0 nm or less, and still more preferably 32.0 nm or less. The average primary particle size of the silica particles is preferably 15.0 nm or more and 39.0 nm or less, more preferably 16.5 nm or more and 34.0 nm or less, and still more preferably 20.0 nm or more and 32.0 nm or less. The average primary particle size of the silica particles can be calculated based on, for example, the specific surface area (SA) of the silica particles calculated from the BET method and the density of the silica particles. More specifically, as the average primary particle size of the silica particles, a value measured by the method described in examples is adopted. The average primary particle size of the silica particles not only may be measured in the silica sol, but also may be measured in a silica aqueous dispersion after a water substitution step because the average primary particle size does not change before and after a concentration step when the water substitution step is performed before the concentration step described later.

The lower limit of the average circularity of the silica particles is preferably 0.70 or more, more preferably 0.75 or more, and still more preferably 0.80 or more. The upper limit of the average circularity of the silica particles is 1.00 or less, and may be 0.99 or less or 0.98 or less. In the present specification, the average circularity means a value obtained by calculating an average of circularities of the silica particles contained in the silica sol. In the present specification, the average circularity means a value calculated by the method described in examples mentioned later. The average circularity of the silica particles not only may be calculated in the silica sol, but also may be calculated in a silica aqueous dispersion after a water substitution step because the average circularity does not change before and after a concentration step when the water substitution step is performed before the concentration step described later.

The concentration of the silica particles in the silica sol according to the present invention is 20 mass % or more. The lower limit of the concentration of the silica particles is preferably 25 mass % or more, and may be 26 mass % or more, 27 mass % or more, 28 mass % or more, 29 mass % or more, or 30 mass % or more. The upper limit of the concentration of the silica particles is, for example, 40 mass % or less, and is preferably 35 mass % or less.

In the silica sol according to the present invention, the total organic carbon (TOC) amount per silica particle is less than 10 mass ppm. The upper limit of the TOC amount per silica particle is preferably 9 mass ppm or less, more preferably 7 mass ppm or less, and still more preferably 5 mass ppm or less. The lower limit of the TOC amount per silica particle is, for example, 0 mass ppm, and may be 1 mass ppm or more, or 2 mass ppm or more. In the present specification, the TOC amount means a value calculated by the method described in examples mentioned later.

The TOC amount of the silica sol according to the present invention is preferably 200 mass ppm or less from the viewpoint of achieving a high purity.

The silica sol according to the present invention does not substantially contain a dispersant from the viewpoint of achieving a high purity. The phrase “does not substantially contain a dispersant” means that the concentration of a dispersant in the silica sol is less than 10 mass ppm. The concentration of a dispersant in the silica sol is preferably 5 mass ppm or less, more preferably 3 mass ppm or less, and still more preferably 0 mass ppm.

In the present specification, the dispersant means an inorganic acid, an inorganic acid salt, an organic acid, and an organic acid salt.

Examples of the inorganic acid include sulfuric acid, hydrochloric acid, nitric acid, phosphoric acid, phosphorous acid, hypophosphorous acid, an alkyl phosphoric acid ester, boric acid, pyrophosphoric acid, borofluoric acid, tetrafluoroboric acid, hexafluorophosphoric acid, benzenesulfonic acid, and naphthalenesulfonic acid.

Examples of the inorganic acid salt include inorganic ammonium salts, and specific examples thereof include ammonium sulfate, ammonium hydrochloride, ammonium nitrate, monoammonium phosphate, diammonium hydrogen phosphate, and ammonium borate octahydrate.

Examples of the organic acid include citric acid, oxalic acid, malic acid, maleic acid, tartaric acid, glutaric acid, adipic acid, pimelic acid, succinic acid, malonic acid, fumaric acid, phthalic acid, formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, and lactic acid.

Examples of the organic acid salt include organic ammonium salts, and specific examples thereof include ammonium benzoate, triammonium citrate, diammonium hydrogen citrate, ammonium oxalate monohydrate, ammonium formate, ammonium salicylate, ammonium adipate, ammonium acetate, and tetramethylammonium citrate.

The viscosity of the silica sol according to the present invention is 300 mPa·s or less at 25° C. when the concentration of the silica particles is 20 mass %. The upper limit of the viscosity of the silica sol is preferably 200 mPa·s or less and more preferably 150 mPa·s or less at 25° C. The lower limit of the viscosity of the silica sol is not particularly limited, but is, for example, 1 mPa·s or more at 25° C. The viscosity of the silica sol may be 30 mPa·s or more and 135 mPa·s or less, or 35 mPa·s or more and 65 mPa·s or less. The viscosity of the silica sol can be measured using a B-type viscometer, and specifically, a value measured by the method described in examples is adopted.

In the silica sol according to the present invention, the concentration of a metal impurity is less than 1 mass ppm, and is preferably 0.5 mass ppm or less. Examples of the metal impurity include sodium, magnesium, aluminum, potassium, calcium, titanium, chromium, manganese, iron, cobalt, nickel, copper, zinc, zirconium, silver, tungsten, and lead. In the present specification, the concentration of a metal impurity means the total concentration of the metal impurities. As the concentration of a metal impurity, a value measured by the method described in examples is adopted.

The pH of the silica sol according to the present invention is not particularly limited. The silica sol according to the present invention does not require adjustment of a pH range for preventing gelation. The pH of the silica sol is preferably 5.0 or more and 8.0 or less, and more preferably 6.5 or more and 7.5 or less. In the present specification, as the pH of the silica sol, a value measured by the method described in examples is adopted.

The method for producing a silica sol according to the present invention is not particularly limited, but it is preferable to use a sol-gel method from the viewpoint of achieving a high purity. The production of the silica sol by a sol-gel method can be performed using a conventionally known method.

Hereinafter, a method for producing a silica sol according to an aspect of the present invention will be described. However, the method for producing a silica sol according to the present invention is not limited to the following aspects.

### <Method for Producing Silica Sol>

One aspect of the present invention relates to a method for producing a silica sol including a reaction step of reacting an alkoxysilane or a condensate thereof in an organic solvent containing water and an alkali catalyst to obtain a reaction liquid containing silica particles; and a concentration step of concentrating the reaction liquid to set a concentration of the silica particles to 20 mass % or more, wherein in the reaction step, a product of an average primary particle size of the silica particles and an average circularity of the silica particles is controlled to 15.0 or more and 31.2 or less. According to the aspect of the present invention, it is possible to produce a silica sol which does not gelate, has a high purity, and contains a high concentration of silica particles.

The method for producing a silica sol according to the present invention includes a reaction step of reacting an alkoxysilane or a condensate thereof in an organic solvent containing water and an alkali catalyst to obtain a reaction liquid containing silica particles.

Examples of the alkoxysilane or the condensate thereof used in the reaction step include tetramethoxysilane, tetraethoxysilane, tetrapropoxysilane, and condensates thereof. These may be used alone, or two or more of these may be used in combination. The alkoxysilane is preferably tetramethoxysilane from the viewpoint of having appropriate hydrolysis reactivity.

As water used in the reaction step, pure water or ultrapure water is preferably used from the viewpoint of reducing contamination of a metal impurity or the like as much as possible.

As the alkali catalyst used in the reaction step, a conventionally known alkali catalyst can be used. The alkali catalyst is preferably at least one of ammonia, tetramethylammonium hydroxide, and other ammonium salts from the viewpoint of being able to reduce contamination of a metal impurity or the like as much as possible. Among them, ammonia is more preferable from the viewpoint of an excellent catalytic action. Ammonia is highly volatile and thus can be easily removed. The alkali catalyst may be used alone, or two or more of the alkali catalysts may be used in admixture.

As the organic solvent used in the reaction step, a hydrophilic organic solvent is preferably used, and specific examples thereof include alcohols such as methanol, ethanol, n-propanol, isopropanol, ethylene glycol, propylene glycol, and 1,4-butanediol; and ketones such as acetone and methyl ethyl ketone. The organic solvent may be used alone, or two or more of organic solvents may be used in admixture.

As the organic solvent, an alcohol is preferable. By using an alcohol, there is an effect that the alcohol can be easily substituted with water by heat distillation when the silica sol is subjected to water substitution described later. From the viewpoint of recovery and reuse of the organic solvent, it is preferable to use the same type of alcohol as the alcohol generated by hydrolysis of the alkoxysilane.

Among the alcohols, at least one of methanol, ethanol, isopropanol, and the like is particularly more preferable. When tetramethoxysilane is used as the alkoxysilane, the organic solvent is preferably methanol.

In the reaction step, a method for reacting an alkoxysilane or a condensate thereof in an organic solvent containing water and an alkali catalyst is not particularly limited, and a conventionally known method can be used. By mixing an alkoxysilane or a condensate thereof with an organic solvent containing water and an alkali catalyst, the alkoxysilane or the condensate thereof is hydrolyzed and polycondensed to produce silica particles.

Hereinafter, an embodiment of the reaction step will be described.

In one embodiment, the reaction step includes mixing a liquid (B) containing an alkoxysilane or a condensate thereof and a second organic solvent, and if necessary, a liquid (C) containing water with a liquid (A) containing an alkali catalyst, water, and a first organic solvent to prepare a reaction liquid containing silica particles.

The contents of the alkali catalyst, water, and the first organic solvent in the liquid (A) are not particularly limited, but the alkali catalyst, water, and the first organic solvent to be used can be changed according to a desired particle size (average primary particle size), and the contents thereof can also be appropriately adjusted according to those to be used.

For example, when ammonia is used as the alkali catalyst, the lower limit of the content of ammonia in the liquid (A) is preferably 0.1 mass % or more, and more preferably 0.3 mass % or more with respect to the entire amount (100 mass %) of the liquid (A) from the viewpoint of the action as a hydrolysis catalyst or the growth of silica particles. The upper limit of the content of ammonia is not particularly limited, but is preferably 50 mass % or less, more preferably 40 mass % or less, and still more preferably 20 mass % or less from the viewpoint of productivity and cost.

The lower limit of the content of water in the liquid (A) is adjusted according to the amount of the alkoxysilane or the condensate thereof used in the reaction, and is preferably 5 mass % or more with respect to the entire amount (100 mass %) of the liquid (A) from the viewpoint of hydrolysis of the alkoxysilane. Further, the upper limit of the content of water is preferably 50 mass % or less, and more preferably 40 mass % or less with respect to the entire amount (100 mass %) of the liquid (A) from the viewpoint of compatibility with the liquid (B). When methanol is used as the first organic solvent, the lower limit of the content of methanol is preferably 10 mass % or more, and more preferably 20 mass % or more with respect to the entire amount (100 mass %) of the liquid (A) from the viewpoint of compatibility with the liquid (B). Further, the upper limit of the content of the first organic solvent is preferably 98 mass % or less, and more preferably 95 mass % or less with respect to the entire amount (100 mass %) of the liquid (A) from the viewpoint of dispersibility.

The contents of the alkoxysilane or the condensate thereof and the second organic solvent in the liquid (B) are not particularly limited, and can be appropriately adjusted according to a desired shape, particle size, or the like. For example, when tetramethoxysilane is used as the alkoxysilane and methanol is used as the second organic solvent, the upper limit of the content of tetramethoxysilane is preferably 98 mass % or less, and more preferably 95 mass % or less with respect to the entire amount (100 mass %) of the liquid (B). The lower limit of the content of tetramethoxysilane is preferably 50 mass % or more, and more preferably 60 mass % or more with respect to the entire amount (100 mass %) of the liquid (B).

The content of water in the liquid (C) is preferably 95 mass % or more, more preferably 98 mass % or more, and particularly preferably 100 mass %.

A reaction liquid containing silica particles is prepared by mixing the liquid (B) and, if necessary, the liquid (C) with the liquid (A). The reaction liquid containing silica particles can be obtained by mixing the liquid (B) and, if necessary, the liquid (C) with the liquid (A) to hydrolyze and polycondense the alkoxysilane or the condensate thereof.

A method for adding the liquid (B) when the liquid (B) is mixed with the liquid (A) is not particularly limited, and continuous addition or divided addition (for example, dropwise addition) may be adopted.

A method for adding the liquid (B) and the liquid (C) when the liquid (B) and the liquid (C) are mixed with the liquid (A) is not particularly limited. A substantially certain amount of each liquid may be simultaneously added to the liquid (A), or the liquid (B) and the liquid (C) may be alternately added to the liquid (A). Alternatively, the liquid (B) and the liquid (C) may be added at random.

A time required to add the entire amount of the liquid (B) or the entire amounts of the liquid (B) and the liquid (C) to the liquid (A) may be, for example, 10 minutes or more although it varies depending on the liquid amounts of the liquid (B) and the liquid (C).

The temperatures of the liquid (A), the liquid (B), and the liquid (C) when the reaction liquid containing silica particles is prepared are not particularly limited. The lower limit of the temperature of each liquid is preferably 0° C. or higher, and more preferably 10° C. or higher. The upper limit of the temperature of each liquid may be the same or different, and is preferably 70° C. or lower, and more preferably 60° C. or lower.

The temperatures of the liquid (A), the liquid (B), and the liquid (C) may be the same or different. The difference in temperature among the liquid (A), the liquid (B), and the liquid (C) is preferably within 20° C. from the viewpoint of controlling the particle size of the silica particles. Here, the difference in temperature means a difference between the highest temperature and the lowest temperature among the three liquids.

The reaction step can be performed under any pressure condition of reduced pressure, normal pressure, and increased pressure. However, from the viewpoint of production cost, the reaction step is preferably performed under normal pressure.

The molar ratio of the alkoxysilane or the condensate thereof, water, the alkali catalyst, and the first and second organic solvents in the reaction liquid containing silica particles is not particularly limited, and can be appropriately adjusted by the content of the alkali catalyst contained in the liquid (A) and/or the alkoxysilane or the condensate thereof contained in the liquid (B).

The molar ratio is a molar ratio of the alkoxysilane or the condensate thereof, water, the alkali catalyst, and the organic solvent (the total amount of the first and second organic solvents) contained in all the liquids used in the reaction, that is, the entire amount of the mixed liquid when the entire amounts of the liquid (A), the liquid (B), and if necessary, the liquid (C) are mixed. To put it plainly, the molar ratio refers to a molar ratio in the entire amount of the mixed liquid after the liquid (B) or the liquid (B) and the liquid (C) are added to the liquid (A) (liquid (A)+liquid (B), or liquid (A)+liquid (B)+liquid (C)).

The molar ratio of water contained in the mixed liquid is preferably 2.0 to 20.0 mol when the number of moles of the alkoxysilane is defined as 1.0. When an N-mer (N represents an integer of 2 or more) alkoxysilane condensate is used, a molar ratio of water in the reaction liquid is N times higher than when an alkoxysilane is used. That is, when a dimer alkoxysilane condensate is used, a molar ratio of water in the reaction liquid is twice higher than when an alkoxysilane is used.

The molar ratio of the alkali catalyst contained in the mixed liquid is preferably 0.1 to 5.0 mol when the number of moles of the alkoxysilane or the condensate thereof is defined as 1.0.

The molar ratio of the total amount of the first and second organic solvents contained in the mixed liquid is preferably 2.0 to 60.0 mol when the number of moles of the alkoxysilane or the condensate thereof is defined as 1.0.

In the reaction step, the product of the average primary particle size of the silica particles and the average circularity of the silica particles is controlled to 15.0 or more and 31.2 or less. The average primary particle size and the average circularity of the silica particles can be controlled by a conventionally known method.

The average primary particle size of the silica particles can be controlled by, for example, a reaction temperature. The reaction temperature is a liquid temperature during the reaction. By increasing the reaction temperature, the average primary particle size can be reduced (see Examples 2 and 3). Further, by lowering the reaction temperature, the average primary particle size can be increased (see Example 2 and Comparative Example 1).

The average circularity of the silica particles can be controlled by, for example, the content of the alkali catalyst and the amount of water in the mixed liquid. By increasing the content of the alkali catalyst, the average circularity can be increased (see Examples 1 and 5). Further, by decreasing the content of the alkali catalyst, the average circularity can be decreased (see Example 2 and Comparative Example 2).

The method for producing a silica sol according to the present invention includes a concentration step of concentrating the reaction liquid to set the concentration of the silica particles to 20 mass % or more.

A method for concentrating the reaction liquid is not particularly limited, and a conventionally known method can be used, and examples thereof include a heat concentration method and a membrane concentration method.

In the heat concentration method, the concentration of the silica particles can be increased by heating and concentrating the reaction liquid containing the silica particles under normal pressure or reduced pressure.

In the membrane concentration method, for example, the concentration of the silica particles can be increased by membrane separation using an ultrafiltration method capable of filtering silica particles. The molecular weight cutoff of the ultrafiltration membrane is not particularly limited, and the molecular weight cutoff can be selected according to the size of particles to be produced. A material forming the ultrafiltration membrane is not particularly limited, and examples thereof include polysulfone, polyacrylonitrile, a sintered metal, a ceramic, and carbon. The form of the ultrafiltration membrane is not particularly limited, and examples thereof include ultrafiltration membranes of spiral type, tubular type, and hollow fiber type. In the ultrafiltration method, the operation pressure is not particularly limited, and can be set to a value equal to or lower than the working pressure of the ultrafiltration membrane to be used.

The method for producing a silica sol according to the present invention further includes a water substitution step of substituting an organic solvent in the reaction liquid with water after the reaction step. The water substitution step can be performed before the concentration step, simultaneously with the concentration step, or after the concentration step.

In the water substitution step, when ammonia is selected as the alkali catalyst, by substituting an organic solvent with water, the pH of the silica sol can be adjusted to a neutral range, and a silica sol with a higher purity can be obtained by removing unreacted substances contained in the silica sol.

As a method for substituting an organic solvent with water, a conventionally known method can be used. Examples thereof include a method in which substitution is performed by heat distillation with dropping water while the liquid amount of the reaction liquid containing the silica particles is maintained at a certain level or more. At this time, the substitution operation is preferably performed until the liquid temperature and the tower top temperature reach the boiling point of water to be used for substitution.

As water used in the water substitution step, pure water or ultrapure water is preferably used from the viewpoint of reducing contamination of a metal impurity or the like as much as possible.

Examples of the method for substituting an organic solvent with water also include a method in which the silica particles are separated by centrifugation of the silica sol and then redispersed in water.

In the method for producing a silica sol according to the present invention, the concentration step may be performed after the water substitution step, the water substitution step and the concentration step may be performed simultaneously, or the water substitution step may be performed after the concentration step. The concentration step and the water substitution step may be performed a plurality of times. For example, the water substitution step may be performed between the concentration step and the concentration step, and after the concentration step, an organic solvent in the concentrated liquid is substituted with water. The water substitution step is performed, and the concentration step of concentrating the liquid resulting from substitution with water may be further performed.

### <Applications of Silica Sol>

The silica sol according to the present invention and the silica sol produced by the production method according to the present invention do not gelate, have a high purity (no dispersant is required, and the concentrations of components other than silica particles and water are extremely low), and contain a high concentration of silica particles (20 mass % or more), and thus can be used in a wider range of applications than before. In particular, the silica sol does not substantially contain an additive component such as a dispersant, and therefore can be suitably used as abrasive grains for polishing an object to be polished such as a semiconductor substrate. Examples of the object to be polished include silicon materials, metals or semimetals such as aluminum, nickel, tungsten, steel, tantalum, titanium, and stainless steel, or alloys thereof; glassy substances such as quartz glass, aluminosilicate glass, and glassy carbon; ceramic materials such as alumina, silica, sapphire, silicon nitride, tantalum nitride, and titanium carbide; compound semiconductor substrate materials such as silicon carbide, gallium nitride, and gallium arsenide; and resin materials such as a polyimide resin. In addition, the silica sol according to the present invention and the silica sol produced by the production method according to the present invention can be used for a filler for a resin (for example, a filler for sealing a semiconductor element), a hard coat agent, a resin modifier, a surface treatment agent, a paint, a pigment, a catalyst, an anti-slip agent, a spacer of a liquid crystal display device, a fiber treatment agent, a binder, an adhesive, a polymer flocculant, a toner, a cleaning agent, a cosmetic, a dental material, a nanocomposite, a heat-sensitive recording body, a photosensitive film, a sediment settling agent, and the like.

The present invention includes the following aspects and forms.

### [1] A Silica Sol Containing Silica Particles and Water, Wherein

a product of an average primary particle size of the silica particles and an average circularity of the silica particles is 15.0 or more and 31.2 or less,
a concentration of the silica particles is 20 mass % or more,
a total organic carbon amount per silica particle is less than 10 mass ppm,
when the concentration of the silica particles is 20 mass %, a viscosity at 25° C. is 300 mPa·s or less, and
a concentration of a metal impurity is less than 1 mass ppm.
   [2] The silica sol according to [1], wherein a pH is 5.0 or more and 8.0 or less.
   [3] The silica sol according to [1] or [2], wherein the concentration of the silica particles is 25 mass % or more.
   [4] The silica sol according to any one of [1] to [3], wherein the average primary particle size of the silica particles is 39 nm or less.

### [5] A Method for Producing a Silica Sol, Including:

a reaction step of reacting an alkoxysilane or a condensate thereof in an organic solvent containing water and an alkali catalyst to obtain a reaction liquid containing silica particles; and
a concentration step of concentrating the reaction liquid to set a concentration of the silica particles to 20 mass % or more, wherein
in the reaction step, a product of an average primary particle size of the silica particles and an average circularity of the silica particles is controlled to 15.0 or more and 31.2 or less.
   [6] The production method according to [5], further including a water substitution step of substituting an organic solvent in the reaction liquid with water after the reaction step, wherein
the water substitution step is performed before the concentration step, simultaneously with the concentration step, or after the concentration step.
   [7] The production method according to [5] or [6], wherein the alkoxysilane is tetramethoxysilane.
   [8] The production method according to any one of [5] to [7], wherein the organic solvent is methanol.

### EXAMPLES

The present invention will be described in more detail with reference to the following examples and comparative examples. However, the technical scope of the present invention is not limited only to the following examples. Unless otherwise specified, “%” and “part(s)” mean “mass %” and “part(s) by mass”, respectively. In addition, in the following examples and comparative examples, unless otherwise specified, operations were performed under the conditions of room temperature (20 to 25° C.)/relative humidity of 40 to 50% RH.

### Examples 1 and 5

A solution obtained by mixing 201 g of methanol and 602 g of tetramethoxysilane (TMOS, manufactured by Tama Chemicals Co., Ltd.) (liquid B) and 150 g of pure water (liquid C) were added dropwise to a solution obtained by mixing 455 g of pure water and ammonia with 5,513 g of methanol (manufactured by Kanto Chemical Co., Inc.) (liquid A) in a flask over 25 minutes while the temperature of each liquid was maintained at 20° C., thereby preparing a reaction liquid containing silica particles.

The content of ammonia in the liquid A was adjusted so as to satisfy Example 1 (103 g)<Example 5.

The obtained reaction liquid was heated and concentrated under normal pressure at a temperature at which the reaction liquid was in a boiling state. When heating and concentration were performed, heat distillation was performed by adding pure water while the liquid surface was kept constant to substitute methanol in the reaction liquid with pure water, thereby obtaining a water-substituted silica aqueous dispersion (silica particle concentration: 6 mass %).

The silica aqueous dispersion was heated under normal pressure at a temperature at which the reaction liquid was in a boiling state to perform thermal concentration so that the silica particle concentration was 30 mass %, thereby obtaining a silica sol. At this time, a flask with a lid was used and steam was recovered with a cooling pipe attached to an upper part of the lid so as not to generate a dried gel.

### Examples 2 to 4

A solution obtained by mixing 194 g of methanol and 582 g of tetramethoxysilane (TMOS) (liquid B) was added dropwise to a solution obtained by mixing 5,885 g of methanol, 1,071 g of pure water, and 186 g of ammonia (liquid A) in a flask over 60 minutes while the temperature of each liquid was maintained constant, thereby preparing a reaction liquid containing silica particles.

The temperature of each liquid was adjusted so as to satisfy Example 2 (55° C.)>Example 4>Example 3.

The obtained reaction liquid was heated and concentrated under normal pressure at a temperature at which the reaction liquid was in a boiling state. When heating and concentration were performed, heat distillation was performed by adding pure water while the liquid surface was kept constant to substitute methanol in the reaction liquid with pure water, thereby obtaining a water-substituted silica aqueous dispersion (silica particle concentration: 6 mass %).

The silica aqueous dispersion was heated under normal pressure at a temperature at which the reaction liquid was in a boiling state to perform thermal concentration so that the silica particle concentration was 25 mass % (Examples 2 and 3) or 30 mass % (Example 4), thereby preparing a silica sol. At this time, a flask with a lid was used and steam was recovered with a cooling pipe attached to an upper part of the lid so as not to generate a dried gel.

### Comparative Example 1

A reaction liquid containing silica particles was prepared in the same manner as in Example 2 except that the temperature of each liquid was adjusted so as to satisfy Comparative Example 1>Example 2.

The obtained reaction liquid was heated and concentrated under normal pressure at a temperature at which the reaction liquid was in a boiling state. When heating and concentration were performed, heat distillation was performed by adding pure water while the liquid surface was kept constant to substitute methanol in the reaction liquid with pure water, thereby obtaining a water-substituted silica aqueous dispersion (silica particle concentration: 6 mass %).

The silica aqueous dispersion was heated under normal pressure at a temperature at which the reaction liquid was in a boiling state to perform thermal concentration. However, when the silica particle concentration reached around 18 mass %, a rapid increase in viscosity occurred and gelation occurred.

### Comparative Example 2

A reaction liquid containing silica particles was prepared in the same manner as in Example 2 except that the content of ammonia in the liquid A was adjusted so as to satisfy Example 2>Comparative Example 2.

The obtained reaction liquid was heated and concentrated under normal pressure at a temperature at which the reaction liquid was in a boiling state. When heating and concentration were performed, heat distillation was performed by adding pure water while the liquid surface was kept constant to substitute methanol in the reaction liquid with pure water, thereby obtaining a water-substituted silica aqueous dispersion (silica particle concentration: 6 mass %).

The silica aqueous dispersion was heated under normal pressure at a temperature at which the reaction liquid was in a boiling state to perform thermal concentration. However, when the silica particle concentration reached around 19 mass %, a rapid increase in viscosity occurred and gelation occurred.

### Comparative Example 3

A reaction liquid containing silica particles was prepared in the same manner as in Example 3 except that the content of ammonia in the liquid A was adjusted so as to satisfy Example 3>Comparative Example 3.

The obtained reaction liquid was heated and concentrated under normal pressure at a temperature at which the reaction liquid was in a boiling state. When heating and concentration were performed, heat distillation was performed by adding pure water while the liquid surface was kept constant to substitute methanol in the reaction liquid with pure water, thereby obtaining a water-substituted silica aqueous dispersion (silica particle concentration: 6 mass %).

The silica aqueous dispersion was heated under normal pressure at a temperature at which the reaction liquid was in a boiling state to perform thermal concentration. However, when the silica particle concentration reached around 19.8 mass %, a rapid increase in viscosity occurred and gelation occurred.

### <Measurement of Average Primary Particle Size>

With respect to the silica aqueous dispersions of Examples 1 to 5 and Comparative Examples 1 to 3, the average primary particle size of silica particles was calculated from the specific surface area of the silica particles measured by the BET method using “Macsorb HM Model-1201” manufactured by Mountech Co., Ltd. and the density of the silica particles. The results are shown in Table 1.

### <Measurement of Average Circularity>

With respect to the silica aqueous dispersions of Examples 1 to 5 and Comparative Examples 1 to 3, the average circularity of silica particles was calculated by the following method.

An observation of an image of the silica aqueous dispersion was performed according to the following procedure using a scanning electron microscope SU8000 (manufactured by Hitachi High-Technologies Corporation).

A sample obtained by dispersing the silica aqueous dispersion in an alcohol, followed by drying was placed on a scanning electron microscope, irradiated with an electron beam at 5.0 kV, and an observation field was photographed at several points at a magnification of 50,000 to 200,000 times.

The photographed SEM image was analyzed using an image analysis type particle size distribution measurement software Mac-View Ver. 4 (manufactured by Mountech Co., Ltd.). Specifically, the circularity was obtained by capturing a SEM image of 100 or more silica particles by SEM and analyzing the image. Therefore, the average circularity was obtained by finding the area (S) of each particle and the perimeter (L) of each silica particle, calculating the circularity of each particle from the following formula, and averaging the circularities. The silica particles used for the calculation of the average circularity included all particles in the photographed SEM image. The results are shown in Table 1:

$$Circularity = 4 π S / {L}^{2} ( S = circle area , L = perimeter ) .$$

### <Measurement of Total Organic Carbon Amount>

With respect to the silica sols of Examples 1 to 5, the total organic carbon (TOC) amount (mass ppm) in the silica sol immediately after production (within 24 hours after preparation) was measured using a total organic carbon meter (TOC-L, manufactured by Shimadzu Corporation), and the TOC amount per silica particle was calculated. The silica aqueous dispersion of Comparative Examples 1 to 3 gelated during thermal concentration, and therefore measurement could not be performed. The results are shown in Table 1.

The TOC amount of the silica sols of Examples 1 to 5 was 200 mass ppm or less.

<Measurement of pH>

The pH of the silica sols of Examples 1 to 5 was measured with a tabletop pH meter (model number: F-72) manufactured by HORIBA, Ltd. The silica aqueous dispersion of Comparative Examples 1 to 3 gelated during thermal concentration, and therefore measurement could not be performed. The results are shown in Table 1.

### <Measurement of Viscosity>

The silica sols of Examples 1 to 5 were loaded in a B-type viscometer TVB-10 manufactured by Toki Sangyo Co., Ltd., and the viscosity was measured under the conditions of a measurement temperature of 25° C. and a rotation speed of 100 rpm. The type of rotor used in the measurement was H3. The results are shown in Table 1.

Further, in Examples 1 to 5, thermal concentration was performed so that the silica particle concentration was 20 mass % to prepare a silica sol, and the viscosity was measured in the same manner as described above. The viscosity of the silica sols of Examples 1 to 5 was 200 mPa·s or less.

### (Measurement of Concentration of Metal Impurity)

With respect to the silica sols of Examples 1 to 5, the amount of a metal impurity was confirmed by measuring the concentration of a metal impurity using inductively coupled plasma (ICP) emission spectrometry. The silica aqueous dispersion of Comparative Examples 1 to 3 gelated during thermal concentration, and therefore measurement could not be performed. The apparatus used was “ICP-AES (model number: ICPS-8100)” manufactured by Shimadzu Corporation. Metal impurities measured were sodium, magnesium, aluminum, potassium, calcium, titanium, chromium, manganese, iron, cobalt, nickel, copper, zinc, zirconium, silver, tungsten, and lead. In the silica sols of Examples 1 to 5, the total concentration of metal impurities was less than 1 mass ppm.

TABLE 1

| | | | Product of | | | |
|---|---|---|---|---|---|---|
| | | | average | | | |
| | Average | | primary | TOC amount | | |
| | primary | | particle size | per silica | | Viscosity at |
| | particle size | Average | and average | particle | | 25° C. |
| | [nm] | circularity | circularity | [mass ppm] | pH | [mPa · s] |
| Example 1 | 26.9 | 0.79 | 21.1 | 4.0 | 6.7 | 61 |
| Example 2 | 16.9 | 0.98 | 16.6 | 3.1 | 6.8 | 39 |
| Example 3 | 32.5 | 0.96 | 31.1 | 4.5 | 6.6 | 131 |
| Example 4 | 23.0 | 0.94 | 21.6 | 2.4 | 6.7 | 58 |
| Example 5 | 30.0 | 0.88 | 26.5 | 3.4 | 6.8 | 37 |
| Comparative | 14.0 | 0.96 | 13.4 | Not | Not | — |
| Example 1 | | | | measurable | measurable | |
| Comparative | 17.7 | 0.83 | 14.8 | Not | Not | — |
| Example 2 | | | | measurable | measurable | |
| Comparative | 34.8 | 0.90 | 31.3 | Not | Not | — |
| Example 3 | | | | measurable | measurable | |

As shown in Table 1, in the silica sols of Examples 1 to 5, since the product of the average primary particle size of the silica particles and the average circularity of the silica particles was within the range of 15.0 or more and 31.2 or less, the silica sols did not gelate and had a low viscosity even when the concentration of the silica particles was set to 25 mass % or 30 mass %. In addition, it can be seen that the silica sols of Examples 1 to 5 have a high purity because the TOC amount per silica particle is extremely low and the concentration of metal impurities is also extremely low. On the other hand, in the silica sols of Comparative Examples 1 to 3, since the product of the average primary particle size of the silica particles and the average circularity of the silica particles was outside the above-mentioned range, the silica sols gelated before the concentration of the silica particles reached 20 mass %. From this, it can be seen that by controlling the product of the average primary particle size of silica particles and the average circularity of silica particles within the predetermined range, a silica sol that does not gelate, has a high purity, and contains a high concentration of silica particles can be obtained.

What is claimed is:

1. A silica sol comprising silica particles and water, wherein
a product of an average primary particle size of the silica particles and an average circularity of the silica particles is 15.0 or more and 31.2 or less,
a concentration of the silica particles is 20 mass % or more,
a total organic carbon amount per silica particle is less than 10 mass ppm,
when the concentration of the silica particles is 20 mass %, a viscosity at 25° C. is 300 mPa·s or less, and
a concentration of a metal impurity is less than 1 mass ppm.

2. The silica sol according to claim 1, wherein a pH is 5.0 or more and 8.0 or less.

3. The silica sol according to claim 1, wherein the concentration of the silica particles is 25 mass % or more.

4. The silica sol according to claim 1, wherein the average primary particle size of the silica particles is 39 nm or less.

5. A method for producing a silica sol, comprising:
a reaction step of reacting an alkoxysilane or a condensate thereof in an organic solvent containing water and an alkali catalyst to obtain a reaction liquid containing silica particles; and
a concentration step of concentrating the reaction liquid to set a concentration of the silica particles to 20 mass % or more, wherein
in the reaction step, a product of an average primary particle size of the silica particles and an average circularity of the silica particles is controlled to 15.0 or more and 31.2 or less.

6. The production method according to claim 5, further comprising a water substitution step of substituting an organic solvent in the reaction liquid with water after the reaction step, wherein
the water substitution step is performed before the concentration step, simultaneously with the concentration step, or after the concentration step.

7. The production method according to claim 5, wherein the alkoxysilane is tetramethoxysilane.

8. The production method according to claim 5, wherein the organic solvent is methanol.
